(19) United States
(12) Patent Application Publication
(10) Pub. No.: US 2024/0239128 A1
(43) Pub. Date: Jul. 18, 2024

(54) BOOK PRINTING MANAGEMENT SYSTEM AND METHOD

(71) Applicant: IMPRIMERIE GAUVIN LTÉE, Gatineau (CA)

(72) Inventor: André GAUVIN, Gatineau (CA)

(21) Appl. No.: 18/558,634

(22) PCT Filed: May 4, 2021
(86) PCT No.: PCT/CA2021/050622

§ 371 Date: Nov. 2, 2023

(51) Int. Cl. B42C 19/02; G06Q 30/0201

(52) U.S. Cl. CPC B42C 19/02; G06Q 30/0206

(57) ABSTRACT

Book printing management computing system and method providing a platform for publishers. The platform allows the publishers to manage their prints, access the archives of all their books in real time and the production parameters of these in its library, its address book, and its production costs. In addition, the platform manages, with several modules not visible to the customer, the overall production schedule and management of orders by APIs.

### FIELD OF THE INVENTION

The present invention relates to book printing management systems and methods, in particular that are related to print-on-demand of books.

### BACKGROUND OF THE INVENTION

Print-on-demand (POD) is a printing technology and business process in which book copies (or other documents) are not printed until the company receives an order, allowing prints of single or small quantities. While other industries established the build to order business model, POD only developed significantly after the beginning of digital printing, because it was not economical to print single copies using traditional printing technology such as letterpress and offset printing.

Prior art POD book workflows involve storing digital book files representing the cover and book block for later reproduction. The book files can be created by a variety of methods, including commercial book publishing software, and scanning and digitally converting hard copy books into computer files. When copies of the book are requested, the book files are retrieved from memory, arranged in the proper order, and then printed.

US20040205462A1 (LEVINE); US20050166143A1 (LEVINE) US20050166143A1 (HOWELL) and US20090254802A1 (CAMPAGNA) disclose different systems for managing and/or printing data files. However, none of these prior art documents discloses an efficient system and method for POD that provides flexibility in printing different book formats without modifying the original book file, and that can provide pricing and delivery estimates that can be easily used by publishers.

### SUMMARY OF THE INVENTION

In embodiments, there is provided a book printing management platform for publishers. This platform allows the publishers to manage their monochrome and color prints, access the archives of all their books in real time (book cover and interior, accessible for download) and the production parameters of these in its library, virtual, online proofs approval before printing, its address book (addresses, predetermined quantities per address if necessary, creation of a group of addresses to integrate into orders), its inventory of pre-printed book covers, its production costs, its press services with insertion of arguments, the reservation of production time, the management of users for the same organization by the administrator (administrator, buyer, collaborator) and management of file transfer to the printing house (upload). In addition, the platform manages, with several modules not visible to the customer, the overall production schedule in digital and offset printing, complete module for processing proofs, their approval and the centralization of archives in real time after approval, the optimization of the choice of materials for production with the use of algorithms, the optimization of production times with the use of algorithms, the management of distributions (deliveries), and management of orders by APIs.

In embodiments, there is provided a tool for publishers to manage the printing and archives of their catalog. For a publisher, the catalog represents all the titles published over the years.

In embodiments, there is provided a book management computing system, comprising: a virtual library including: a book file input for receiving and storing customer book files; a book estimate request input for receiving a book print-on-demand estimate request, said book print-on-demand estimate request including book data parameters, said book data parameters including: book identification data, book quantity, book format and address of delivery; a book estimate output for transmitting book print-on-demand estimate data based on the book print-on-demand estimate request input and book pricing and production parameters; a book order input for receiving a book print-on-demand order, said book print-on-demand order including the book data parameters of said book print-on-demand estimate request; and a book order output for transmitting book order data to a user.

In embodiments, the book data parameters comprise one or more of the following: a book cover paper type, cover lamination type, book inner paper type, book bindery, number of pages, book spine size, book width, book height, book print text color.

In embodiments, the virtual library comprises an input configured to receive international metadata book files, e-book files and audio book files to store the files in the virtual library and an output for accessing said international metadata book files, e-book files and audio book files by a user.

In embodiments, there is provided a method for operating a book management computing system, the method comprising: receiving a book print-on-demand estimate request of a book file, said book print-on-demand estimate request including book data parameters, said book data parameters including: book identification data, book quantity, book format and at least one address of delivery; transmitting book print-on-demand estimate data based on the book print-on-demand estimate request and book pricing and production parameters; and receiving a book print-on-demand order, said book print-on-demand order including the book data parameters of said book print-on-demand estimate request.

In embodiments, the method comprises at least one of: running an application (API) configured for connection to the inputs and outputs of the virtual library, storing the book file in an archive data base, printing a set of books based on said book order associated with said book identification data, said book quantity and said book format, shipping said books to said at least one address of delivery.

### BRIEF DESCRIPTION OF THE DRAWINGS

FIG. 1 is a block diagram of a book printing system, according to a preferred embodiment of the present invention.

FIG. 2 is a block diagram of a book printing system using an API, according to a preferred embodiment of the present invention.

### DETAILED DESCRIPTION OF THE ILLUSTRATIVE EMBODIMENTS

Referring to the Figures, there is show an example of book management system 10, according to a preferred embodiment of the present invention.

At the core of the system 10 there is a virtual library 12, which is configured to centralize the metadata from the production of books. The virtual library 12 offers editors management of archives of their books, cost optimization, production and deliveries for print-on-demand (POD), micro-prints, short and medium-sized prints. The virtual library 12 is built from parameters files (described below) and algorithms to determine in real time optimized production process, price and delivery.

At the front end of the virtual library 12, a user may see his entire catalog of titles (metadata and archives). The user may have unlimited access to his virtual library with searching tools (title, primary key words, service, collection, author, ISBN and dates). The user may manage printing (and distribution) of his entire catalog, as well as automatic data and files exchange with an API (Application Programming Interface). The user may follow order status, follow order in production, follow order history, follow files to be transferred, all metadata and production information (including live PDF's for printing of CVR and TXT), including visualization of type of service availability for each title, all in one screen.

At the back end of the virtual library 12, the system 10 takes charge of different requests. In a new title request, data is coded and placed in a data file ready to be ordered. In an estimate print-on-demand request, data is analysed with sequential parameters and algorithms. Once analysed, the estimate request is priced (printing and delivery). Also, an output to a customer book order (at a server using an API or not) is similar than the estimate print-on-demand request but ads an order confirmation (with lot number/order number and lot admin number).

In particular, the system 10 stands out for its production flexibility in two formats: Small (6″×9″ and smaller such as down to 4″×6″) and Large (larger than 6″×9″ up to 9″×12″). This gives publishers a wide variety of book formats used in the industry. In addition, the system 10 stands out by offering in POD, eight types of inner papers, two types of cover papers and two kinds of lamination finishes. The flexibility of the system 10 stems from the choice of technologies (sheet printing of cover and interior) and the development of system specific processes.

Algorithms optimize production grouping according to the following sequence decision-making process for PODs: the quantity, the format of the book (Small/Large), and the lamination type on the cover, regardless of the type of paper chosen for the cover and interior.

The grouping effect optimizes the costs and the process of production which results in a competitive unit price.

Another algorithm optimizes the following decision-making sequence for micro-run, short and medium prints: the quantity, the format of the book, the number of pages. The number of pages determine the process of production, printing and binding (signature or cut blocks). Currently the system determines the choice of the production process with the variable entered in the parameters file at 248 pages.

According to the decision-making sequence, the system 10 routes the parameters optimized in XML or ONIX to a “workflow” printing.

In a current form, the system offers printing from 1 to 1500 copies under three different services: PRESTO™, PLUS™, BASE™. For system the POD and micro-draft (1-50) are part of the service PRESTO.

The quantities offered in the various system services are editable. They are defined in the algorithms.

Thanks to the variety of paper offerings, the system 10 allows publishers to maintain the physical specifications of the book (cover type, lamination type, interior paper type) throughout the commercial life of the book, without modification of print files.

In known POD systems that are currently on the market, the parameters must adapt to the offerings of suppliers, which push the publisher to edit print files for reprints (format adjustment, book thickness).

However, according to the present system, an ordered title, available in the virtual library 12, without modification, is reprinted in the next available production window, depending on the quantity.

The system 10 reserves production time (printing, binding, shipping) for a predetermined time (for example 15 minutes) in the shopping cart of the customer, or as long as there is action in the customer's virtual library 12 and confirms when the customer passes the order.

### Parameter File

The parameter file establishes rates and paper size for production based on format of the ordered book. The parameters include: Calculation of profit margins, price of use of the service, tariffs schedules of the various production stations, paper prices for covers and interiors, paper basic weight for covers and interiors, availability of cover papers and interiors according to the services offered by the system 10, inner paper thickness PPI (pages per inch) and paper thickness cover to automatically determine the spines of books, paper sizes used for the production versus format of books with their minimum size and maximum per paper size (optimization), variables for production in signatures vs cut block including staging copies that are made ready (i.e. to prepare and adjust equipment in order to carry out the various stages of a book's production) and the percentages of additional saleable copies (no additional copy in the PRESTO™ service), price raw materials other than paper, shipping rates, prices of boxes, weight of finished books, box dimensions, optimization box formats according to the format of the book.

The algorithms for the price calculation are integrated into the source code.

The system 10 optimizes the calculation of the number of boxes according to weight and book format. In addition, it optimizes the number of boxes on pallet(s) for shipments by LTL transport (Less than truckload (LTL) freight is the transportation of products or goods that does not require a full truckload due to the smaller nature of the parcel).

In the PRESTO™ service, calculations are determined when we group books of different sizes inside one of the two defined formats (Small/Large), of different thicknesses, if the book covers are laminated with the same film.

There are two types of lamination available in PRESTO™: glossy and matte. Therefore, one can have, for example, a glossy lot with 10 or 12 pts covers, interiors of books in all different sizes, with the same type of paper or different papers. These lots are printed on the same size of inner paper for all books, regardless of the format of the books that come into the Small/Large format. For the Small size, one can use 12.5″×19.25″ paper. For the Large format, one can use 19″×12.5″ paper. The system 10 may also consider the grain direction of the paper, depending on its format.

The system 10 may create print batches in sequence, in signatures of 8 or 4 pages. This allows bundles of books to be bound without interruption.

The virtual library 12 may be connectable to various modules:
access to the cover and interior archives by the client by means of an Archives module 20 containing PDF, CVR TXT printing files and a Cover Inventory Management module 22;
automated management of events: complete module of processing of proofs by means of a Proofing Management module 24, their approval and centralization of real-time archives after approval;
creation of new titles by the client (the client can fill in his virtual library) by means of a Titles and Order Management module 28;
real-time multi-quantity estimation by means of an Integrated Data Base module 25 and Accounting module 27;
estimation of transport costs to one or multiple address(es) by means of a Shipping-Packaging Management module 26;
address book management also allowing the creation of address groups by means of an Addresses Management module 30;
user management for the same organization (administrator, buyer, collaborator) by means of a Users Management module 32;
management of complex pre-printed covers, kept in inventory at the system and used for PLUS™ and BASE™;
press service management for publishers with sales pitch integrated into shipments by means of an Advance Reader Copy (ARC) Management module 34;
communication module by each stage of production to various production stations using bar codes;
API client/customer server link 30 to the system and API Courier Link module 36: Upon receipt a third party order on the customer's site, the system receives the order directly, prints and binds the book and ships to the third party;
production schedule and workflow management module 38 (press time digital and offset press, assembly, binding, shipping);
production time reservation by means of the Calendar Management module 40 by customers for prints of 51 copies or more.

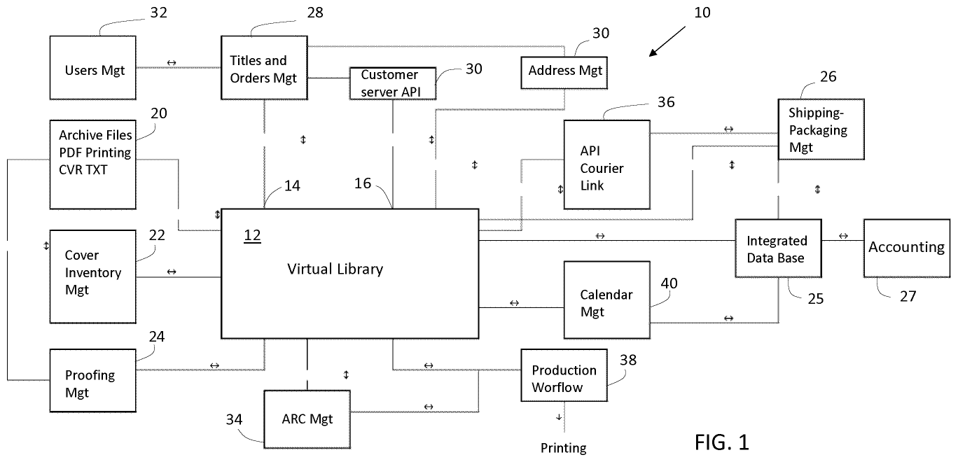

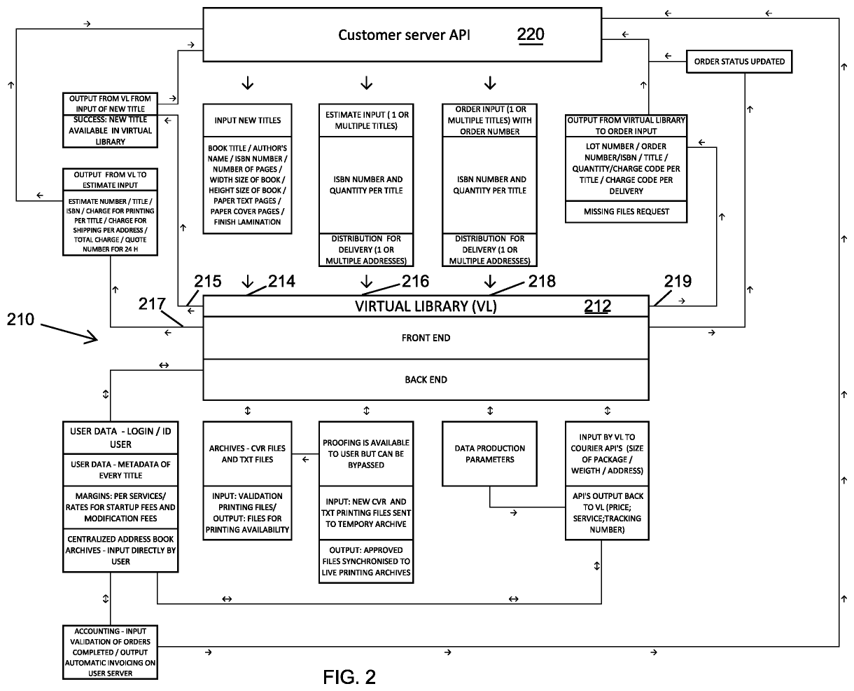

Referring now to FIG. 2, in addition to FIG. 1, there is shown a book printing system 210 using a customer server API 220, according to a preferred embodiment of the present invention. A virtual library 212 similar to the virtual library 12 shown in FIG. 1. The virtual library 212 is connectable to the customer server API 220 via different inputs at its front end. As persons skilled in the art will understand, the present system 10 may be used without an API.

A first input 214 or book file input 214 is used to input new titles. The book file input 214 is configured to receive customer book files so that these may be stored in the virtual library 212 or in an archive data base. The book files may contain book identification data including for example: book title, author's name, ISBN number, number of pages, width size of book, height size of book, paper text pages, paper cover pages, and finish lamination. A second input 216 or book print-on-demand estimate input 216 is used by the user to input one or more titles associated with an ISBN number and quantity per title, as well as distribution for delivery at one or multiple addresses. A third input 218 is used for receiving a book order from the user. The book order includes the book data parameters of the book print-on-demand estimate request. A first output 215 of the virtual library informs the user if there is an availability of a new title in the virtual library. A second output 217 of the virtual library is used to provide to the user a book print-on-demand estimate data based on the book print-on-demand estimate request input and book pricing parameters. A third output 219 of the virtual library is used for transmitting book order data to the user.

At the back end of the virtual library 212, there is a connection to a user data module. The user data module is used for login and identifying the user. The user may be an administrator, a collaborator or a buyer. The user data module may include the metadata of every title, input new title data and files location, input new orders, which correspond to the output transfer data of title (or new title) into a live project. The title must be created first (either by the user or API). When created, the title is accessible on the virtual library 212 and can be ordered. The data needed for new title creation includes: title, author, collection, ISBN, number of pages, spine size, width, height, paper CVR, printing CVR, paper TXT, printing TXT, bindery, and finish lamination.

The user data module may also include margins data: per services, including couriers and transports, rates for startup fees and modification fees. The user data module may include centralized address book archives that are input directly by the user. The user data module is in communication with an accounting module. The accounting module has as input the validation of orders completed and as an output the automatic invoicing on the user server.

At the back end of the virtual library 212, the virtual library 212 is also in communication with an archives module that contains CVR files and TXT files. The archives module performs automatic synchronisation with every request and automatic proof approval. The files are live for production. The archives module has an input for input for validation if printing files (CVR and TXT) are in place. The archives module has an output to inform if files for printing are available or missing. The archives module is in communication with a proofing module that is available to the user but may be bypassed. The proofing module verifies the new title files and modified files (CVR and/or TXT). The approval by the user synchronizes the files to be live production files. The proofing module has an input: new CVR and TXT printing files sent to temporary archive and an output: approved files synchronised to live printing archives. Note that if older files (CVR and or TXT) are ready in live printing archives, new approved files will replace them.

The virtual library 212 is also in communication with a data production parameters module. The virtual library also is in communication with a shipping module that has an input by virtual library to the courier's API providing shipping data such as size of package, weight and address. The shipping module receives the API's output back to the virtual library order data that included: price, service, tracking number.

The scope of the claims should not be limited by the preferred embodiments set forth in the examples but should be given the broadest interpretation consistent with the description as a whole.

1. A book management computing system for feeding a known print-on-demand (POD) system, the book management computing system comprising:
a virtual library including:
a book file input for receiving and storing unmodified customer book files;
a book estimate request input for receiving a book print-on-demand estimate request, said book print-on-demand estimate request including book data parameters, said book data parameters including: book identification data, book quantity, book format and address of delivery;
a book estimate output for transmitting book print-on-demand estimate data based on the book print-on-demand estimate request input and book pricing and production parameters;
a book order input for receiving a book print-on-demand order, said book print-on-demand order including the book data parameters of said book print-on-demand estimate request; and
a book order output for transmitting said book data parameters and the unmodified customer book files to the known print-on-demand system.

2. The system of claim 1, wherein the book data parameters comprise one or more of the following: a book cover paper type, cover lamination type, book inner paper type, book bindery, number of pages.

3. The system of claim 1, wherein the virtual library comprises an input configured to receive international metadata book files, e-book files and audio book files to store the files in the virtual library and an output for accessing said international metadata book files, e-book files and audio book files by a user.

4. The system of claim 1, wherein the book data parameters include a book spine size.

5. The system of claim 1, wherein the book data parameters include a book width and/or height.

6. The system of claim 1, wherein the book data parameters include a book print text color.

7. The system of claim 1, wherein the book identification data comprises an ISBN number.

8. The system of claim 1, further comprising a user device running an application programming interface (API) configured for connection to the book file input, the book order input, the book estimate request input, the book estimate output and book order output of the virtual library.

9. A method for operating a book management computing system to feed a known print-on-demand (POD) system, the method comprising:
receiving and storing unmodified customer book files;
receiving a book print-on-demand estimate request of book files, said book print-on-demand estimate request including book data parameters, said book data parameters including: book identification data, book quantity, book format and at least one address of delivery;
transmitting book print-on-demand estimate data based on the book print-on-demand estimate request and book pricing and production parameters;
receiving a book print-on-demand order, said book print-on-demand order including the book data parameters of said book print-on-demand estimate request; and
transmitting said book data parameters and the unmodified customer book files to the known print-on-demand system.

10. The method of claim 9, wherein the book data parameters comprise one or more of the following: book cover paper type, cover lamination type, number of pages, book inner paper type, book bindery, book spine size, book width, book height, book print text color.

11. The method of claim 9, comprising running an application programming interface (API) configured for connection to the book file input, the book order input, the book estimate request input, the book estimate output and book order output of the virtual library.

12. The method of claim 9, comprising storing the book files in an archive data base.

13. The method of claim 9, comprising printing a set of books based on said book order associated with said book identification data, said book quantity and said book format.

14. The method of claim 13, comprising shipping said books to said at least one address of delivery.
